(19) United States
(12) Patent Application Publication
(10) Pub. No.: US 2025/0164812 A1
(43) Pub. Date: May 22, 2025

(54) ELECTRONIC DEVICE INCLUDING ADJUSTABLE DISPLAY

(71) Applicant: Apple Inc., Cupertino, CA (US)

(72) Inventors: Antony John Edathattil, Sunnyvale, CA (US); Adam Y. Kollgaard, San Jose, CA (US); Matin Seadat Beheshti, Sunnyvale, CA (US); Kevin Ceurter, Olympia, WA (US); John Cagle, San Jose, CA (US); Killian J. Poore, San Jose, CA (US)

(21) Appl. No.: 18/903,827

(22) Filed: Oct. 1, 2024

Related U.S. Application Data
(60) Provisional application No. 63/600,432, filed on Nov. 17, 2023.

(51) Int. Cl. G02B 27/01

(52) U.S. Cl. CPC G02B 27/0179; G02B 27/0176; G02B 2027/0154; G02B 2027/0187

(57) ABSTRACT

Head-mountable electronic devices including adjustable displays and methods of using the same are disclosed. In an example, a head-mountable electronic device includes a display unit including a display, a first frame coupled to the display, a second frame coupled to the first frame by a first actuator, and a securement strap coupled to the second frame. The first actuator can be configured to adjust a distance between the first frame and the second frame, and the first actuator can be non-backdrivable.

### CROSS-REFERENCE TO RELATED APPLICATION(S)

This application claims the benefit of U.S. Provisional Patent Application No. 63/600,432, filed 17 Nov. 2023, and entitled “ELECTRONIC DEVICE INCLUDING ADJUSTABLE DISPLAY,” the entire disclosure of which is hereby incorporated by reference.

### FIELD

The described embodiments relate generally to electronic devices. More particularly, the present embodiments relate to head-mountable electronic devices.

### BACKGROUND

Recent advances in portable computing have enabled head-mountable devices that provide augmented and virtual reality experiences to users. Various components of these devices, such as displays, viewing frames, securement straps, speakers, batteries, and other components, operate together to provide an immersive and comfortable experience. Users of head-mountable devices can prefer the displays of these devices to be disposed at different differences from their eyes for various reasons. As a result, a head-mountable device that includes a display that is adjustable relative to a user's eyes is desired.

### SUMMARY

In at least one example of the present disclosure, a head-mountable electronic device includes a display unit including a display, a first frame coupled to the display, a second frame coupled to the first frame by a first actuator, and a securement strap coupled to the second frame. The first actuator can be configured to adjust a distance between the first frame and the second frame. The first actuator can be non-backdrivable.

In some examples, the first actuator can include a motor. The first actuator can include a spring. The spring can be configured to increase the distance between the first frame and the second frame in response to a trigger by the head-mountable electronic device. The first actuator can include a button and the distance can be configured to be adjusted when the button is actuated.

In some examples, the second frame can be further coupled to the first frame by a second actuator. The second actuator can be configured to adjust an angle of the first frame relative to the second frame. The first actuator can include a dial and the distance can be configured to be adjusted when the dial is rotated.

In at least one example of the present disclosure, a wearable electronic device includes a display, a device seal configured to physically interface with a user, and an actuator coupled to the display and the device seal. The actuator can be configured to adjust a position of the display unit relative to the device seal in response to a signal from the wearable electronic device.

In some examples, the actuator can include a manual actuator. The display can be configured to display instructions for adjusting the position of the display unit relative to the device seal.

In some examples, the actuator can be configured to adjust a distance between the display and the device seal. The actuator can be configured to adjust an angle of the display relative to the device seal.

In some examples, the actuator can be a first actuator and the first actuator can be configured to adjust a distance between the display and the device seal. The wearable electronic device can further include a second actuator and the second actuator can be configured to adjust an angle of the display relative to the device seal.

In some examples, the actuator can include a detent configured to maintain the position of the display relative to the device seal.

In at least one example of the present disclosure, a head-mountable device (HMD) includes a display, a facial interface, and an actuator connecting the display to the facial interface. The actuator can include a motor configured to adjust a distance between the display and the facial interface.

In some examples, the actuator can be configured to adjust the distance between the display and the facial interface based on an activity setting of the HMD. The actuator can be configured to adjust the distance between the display and the facial interface based on a body position of a user of the HMD.

In some examples, the HMD can further include a sensor configured to provide feedback related to an environment around the HMD. The actuator can be configured to adjust the distance between the display and the facial interface based on the feedback from the sensor.

In some examples, the HMD can further include a sensor configured to analyze facial features of a user of the HMD. The actuator can be configured to adjust the distance between the display and the facial interface based on the facial features of the user.

In some examples, the HMD can further include a sensor and a second actuator. The sensor can be configured to detect a gaze of a user of the HMD. The second actuator can be configured to adjust a relative angle between the display and the facial interface based on the gaze of the user detected by the sensor.

In some examples, the actuator can be configured to adjust the distance based on a user profile associated with a respective user of the HMD.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a top-down view of a head-mountable device.

FIG. 1B shows a side view of a head-mountable device worn by a user.

FIG. 2 shows a side view of a head-mountable device worn by a user.

FIGS. 3A, 3B, and 3C show side views of head-mountable devices including various actuators.

FIGS. 4A, 4B, and 4C show side views of a head-mountable device with actuators in varying positions.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to wearable electronic devices (e.g., head-mountable devices (HMDs)). More particularly, the present examples relate to HMDs that include displays with positions that are adjustable relative to a user's eyes.

In some examples, a head-mountable device can include a display unit and a securement strap extending from the display unit. The head-mountable device can be secured on a user's head by the securement strap such that a display of the display unit is positioned in front of the user's eyes. Users can prefer the display to be disposed at different distances from their eyes depending on user preferences, activities performed while wearing the head-mountable device, a position of the user's body, the user's surroundings, and the like.

A head-mountable device of the present disclosure includes a display that is adjustable relative to the eyes of a user of the head-mountable device. More specifically, the display is adjustable such that a distance between the user's eyes and the display is adjustable. As will be discussed in detail below, the head-mountable device can include actuators that can be used to adjust the position of the display relative to the user's eyes. The actuators can include automatic actuators (e.g., motors or the like), manual actuators (e.g., dials, buttons, slidable actuators, spring-loaded actuators, telescoping actuators, linkages, combinations thereof, or the like), combinations thereof, or the like. The head-mountable device can include one actuator and can be limited to adjusting a distance between the display and the user's eyes, or can include a plurality of actuators and can further adjust an angle of the display relative to the user's eyes. Providing the head-mountable device with actuators to adjust the position of the display relative to the user's eyes can increase user comfort, allow for a single head-mountable device to be used by users having varying facial features, allow the head-mountable device to better suit user preferences, allow for different positions of the display to be used for different activities and different body positions of the user, maintain comfortable relative distances between the user and the display when wearing the head-mountable device, and the like.

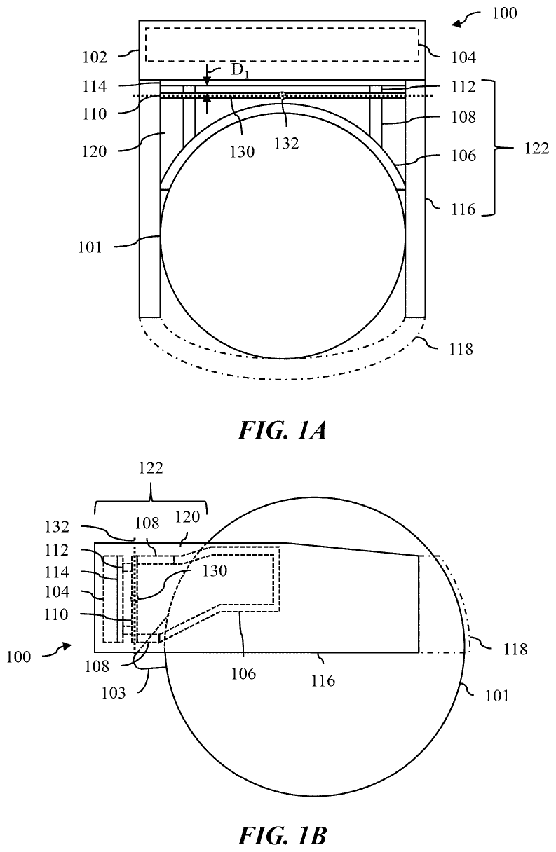

These and other embodiments are discussed below with reference to FIGS. 1A through 4C. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A and 1B illustrate a top-down view and a side view, respectively, of a head-mountable device (HMD) 100 worn on a user's head 101. The HMD 100 can include a display 102, a facial interface 106, a first frame 110, a second frame 114, straps 116, a band 118, a cover 120, and a device seal 122. As will be discussed in detail below, the second frame 114 can be coupled to the first frame 110 by actuators 112, which allow relative positions of the second frame 114 and the first frame 110 to be adjusted. This configuration also allows for relative positions of the display 102 and the user's eyes to be adjusted. Although the particular component 100 can be referred to as an HMD, it should be understood that the terms wearable device, wearable electronic device, HMD device, and/or HMD system can be used to refer to any wearable device, including smart glasses.

The display 102 can include one or more optical lenses or displays that are configured to be positioned in front of the user's eyes. The display 102 can include a display 104 configured to present an augmented reality visualization, a virtual reality visualization, or another suitable visualization to the user. The display 104 can be positioned at least partially in or on the second frame 114. The second frame 114 can be a housing of the display 102. In some examples, the device seal 122 includes the second frame 114 (e.g., the second frame 114 can be part of the device seal 122). The second frame 114, the display 102, and the device seal 122 can collectively form a display housing.

The device seal 122 can include the facial interface 106, the cover 120, the first frame 110, and electrical components. The device seal 122 can also be referred to as a light seal or a facial interface configured to seal the user's eyes from ambient light. In some examples, the device seal 122 can refer to a portion of the HMD 100 that engages or shields the user's face. The device seal 122 can include portions of the HMD 100 that conform to, contact, or press against regions of the user's face (e.g., the facial interface 106). The facial interface 106 can conform to (e.g., compress against and assume the shape of) regions of the user's face. In some examples, the facial interface 106 can include pliant (or semi-pliant) materials that span a forehead region, wrap partially around the eyes, and contact the zygoma and/or maxilla regions of the user's face.

The cover 120 can include a seal, a facial interface, an environment seal, a dust seal, an air seal, or the like that is positioned between the display 102 and the user's face. The cover 120 can be a woven fabric that is non-rigid or deformable. The cover 120 can be elastically deformable. In some examples, the cover 120 can be a plastic, a rubber, or a polymer material. In some examples, the cover 120 can be rigid. In some examples, the cover 120 can expand and contract, such as when a distance between the first frame 110 and the second frame 114 is adjusted. The cover 120 can be formed of an elastic material, an accordion shaped material, a telescoping material, or the like. The cover 120 can form an eye-box through which the user can view the display 102. It will be appreciated that the term “seal” can include partial seals or inhibitors, in addition to complete seals (e.g., a partial light seal where some ambient light is blocked, or a complete light seal where all ambient light is blocked when the HMD 100 is donned).

The first frame 110 can be coupled to the facial interface 106 by connectors 108. In some examples, the connectors 108 allow the facial interface 106 to translate and/or rotate relative to the first frame 110. The connectors 108 can moveably constrain the facial interface 106 to the first frame 110. In other words, the connectors 108 can provide for controlled movement between the facial interface 106 and the first frame 110, which can be used to ensure that the facial interface 106 molds to or otherwise conforms to facial features of the user's head 101. In some examples, the connectors 108 can be provided adjacent to facial features of the user's head, such as a forehead region, a zygoma region, and/or a maxilla region. However, the connectors 108 can be provided at any desired locations. The connectors 108 can include one or more joints (e.g., pivot joints, soft joints, flexure joints, spring joints, or the like) that allow (or actively provide) translation and/or rotation of the facial interface 106 relative to the first frame 110.

The straps 116 and/or the band 118 can retain the HMD 100 relative to the user's head 101. The straps 116 can be connected to the device seal 122 and can extend distally toward a rear of the user's head 101. In some examples, the straps 116 can be extensions of the display housing, such as the device seal 122. The straps 116 can be coupled to left and right sides of the device seal 122 to physically and/or electrically couple the straps 116 to the device seal 122. The straps 116 can further be physically and/or electrically coupled to the display 102, either directly or through the device seal 122. The straps 116 are configured to secure the display 102 in a position relative to the user's head 101 (e.g., such that the display 102 is maintained in front of the user's eyes). For example, the straps 116 can extend over the user's ears. In some examples, the straps 116 can rest on the user's ears to secure the HMD 100 via friction between the straps 116 and the user's head 101. For example, the straps 116 can apply opposing pressures to the sides of the user's head 101 to secure the HMD 100 to the user's head 101. Optionally, the straps 116 can be connected to each other via the band 118, which can compress the HMD 100 against the user's head 101. The straps 116 can contain sensors, buttons, speakers, and/or other electrical components. Hinges and/or other mechanisms can be used to couple the straps 116 to the device seal 122. In some examples, the straps 116 can be formed integrally as portions of the device seal 122.

The second frame 114 can be coupled to the first frame 110 by actuators 112. The actuators 112 can be provided in order to allow relative positions of the first frame 110 and the second frame 114 to be adjusted. This can be used to control relative positions of the display 104 and the user's eyes. The actuators 112 can provide control over a distance D1 between the first frame 110 and the second frame 114 (e.g., altering a distance between the user's eyes and the display 104), a pitch angle between the first frame 110 and the second frame 114 (e.g., an angle in a pitch axis 130 parallel to a longitudinal axis of the display 102), a yaw angle between the first frame 110 and the second frame 114 (e.g., an angle in a yaw axis 132 perpendicular to the longitudinal axis of the display 102 and longitudinal axes of the straps 116), or any other desired variables in the relative positions of the first frame 110 and the second frame 114. In some examples, the distance Di can range from about 5 mm to about 45 mm, from about 5 mm to about 38 mm, from about 15 mm to about 36 mm, or the like. The actuators 112 can supply a travel of about 5 mm, about 10 mm, about 15 mm, about 20 mm, up to about 40 mm, or the like. The actuators 112 can be coupled to the first frame 110 and/or the second frame 114 through ball joints or other joints that allow the actuators 112 to pivot relative to the first frame 110 and/or the second frame 114, which allows for adjustment of the pitch angle, the yaw angle, and other relative angles between the first frame 110 and the second frame 114. Providing the actuators 112 to adjust the relative positions of the first frame 110 and the second frame 114 can improve user comfort, increase or otherwise improve the user's field of view of the display 104, accommodate users with varying facial features and personal preferences, provide users with a more immersive experience while wearing the HMD 100, and the like.

In some examples, the actuators 112 can be positioned between the first frame 110 and the second frame 114 in positions aligned with features on the user's face, such as being aligned with the user's forehead and the user's zygoma and/or maxilla regions. In some examples, the HMD 100 can include four actuators 112, with two actuators 112 positioned in alignment with the user's forehead and two of the actuators 112 aligned with the user's zygoma and/or maxilla regions. The HMD 100 can include more or fewer of the actuators 112, and the actuators can be positioned in any desired positions between the first frame 110 and the second frame 114. Providing a greater number of the actuators 112 can provide control over a greater number of variables (e.g., axial relationships) in the relative positions of the first frame 110 and the second frame 114. For example, a single actuator 112 can be provided to allow adjustment of the distance between the first frame 110 and the second frame 114. Two actuators 112 can be provided to allow adjustment of the distance between the first frame 110 and the second frame 114 and an angle between the first frame 110 and the second frame 114 along a first axis. Three actuators 112 can be provided to allow adjustment of the distance between the first frame 110 and the second frame 114 and angles between the first frame 110 and the second frame 114 along a first axis and a second axis. Any number of the actuators 112 can be provided, depending on the number of variables in the relative positions of the first frame 110 and the second frame 114 desired to be controlled.

Any suitable actuators can be used for the actuators 112. The actuators 112 can be manually or automatically actuated, such as actuated in response to a signal from a processor or other electronic device. In examples in which the actuators 112 are automatically actuated, the actuators 112 can include motors controlled by the HMD 100. The motors can include Piezo motors, LVDT electromagnetic actuators, micro hydraulic actuators, brushed or brushless DC motors, stepper motors, any other suitable motors, or the like. In examples in which the actuators 112 are manually actuated, the HMD 100 can provide prompts for the user to adjust the actuators 112. The manually actuated actuators 112 can include dials, buttons, slidable actuators, ratchet bands, spring-loaded actuators, telescoping actuators, or the like. The actuators 112 can be used in combination with or can include linkages, such as scissor linkages, Hoecken linkages, rack and pinion linkages, pulleys, lead screws, or the like. The linkages can convert rotational motion of the actuators 112 to translational motion of the second frame 114 relative to the first frame 110, or can convert other motion of the actuators 112 into desired motion of the second frame 114 relative to the first frame 110. In the example illustrated in FIGS. 1A and 1B, the actuators 112 are disposed perpendicular to longitudinal axes of the display 102 and the straps 116; however, the actuators 112 can be disposed at any desired angles relative to the display 102 and the straps 116, and the linkages can be used to produce desired motion of the second frame 114 relative to the first frame 110 regardless of the positions of the actuators 112.

The actuators 112 can be non-backdrivable. For example, the actuators 112 can include non-backdrivable motors or detents. The detents can include buttons, holes and pins, fasteners, ratchets and pawls, combinations thereof, or the like. The actuators 112 can be non-backdrivable in one direction, or in multiple directions. Providing non-backdrivable actuators 112 prevents the second frame 114 from being moved from a position relative to the first frame 110, unless the actuators 112 are actuated. In examples in which the actuators 112 include detents, the detents can be disengaged (such as by pressing a button), the actuators 112 can be used to move the second frame 114 relative to the first frame 110, and the detents can be engaged (such as by releasing the button). This prevents the display 102 from collapsing towards the user's face when the display 102 contacts an external object. This also prevents unwanted movement of the display 102 relative to the user's eyes as the HMD 100 is used.

In some examples, the HMD 100 can be used while the user performs activities having various activity types. These activity types can include dynamic activities, sedentary activities, activities that are more or less immersive, or the like. The actuators 112 can adjust the relative positions of the second frame 114 and the first frame 110 based on an activity type for which the HMD 100 is used. For example, the distance between the second frame 114 and the first frame 110 can be increased by the actuators 112 for dynamic activities where increased relative distances is desired and optical quality is less important. The distance between the second frame 114 and the first frame 110 can be decreased by the actuators 112 for sedentary activities and immersive activities, where optical quality and field of view are more important. As such, the actuators 112 can be included to improve optical quality, comfortable respective positioning, and field of view in the HMD 100.

In some examples, the HMD 100 can include one or more sensors, and the actuators 112 can be used to adjust relative positions of the first frame 110 and the second frame 114 (e.g., relative positions of the user's eyes and the display 102) based on signals produced by the sensors. For example, the HMD 100 can include inward-facing optical sensors that detect and track a gaze of a user of the HMD 100. The actuators 112 can move the second frame 114 relative to the first frame 110 corresponding to a direction of the user's gaze. In some examples, applications accessed by the HMD 100 can use the actuators 112 to move the second frame 114 relative to the first frame 110 in order to prompt the user to gaze in a desired direction. In some examples, the HMD 100 can include inward-facing optical detectors or the like that detect and analyze facial features of the user of the HMD 100. These facial features can be used by the HMD 100 to determine an optimal eye relief for the user, and the actuators 112 can move the second frame 114 relative to the first frame 110 to provide the user with the optimal eye relief. In some examples, the HMD 100 can include outward-facing optical detectors, inertial measurement units, and the like, which can detect the environment around the user and the user's interaction with or movement through their environment. This environmental data can be used with the actuators 112 to move the second frame 114 relative to the first frame 110 in order to provide the user with warnings or other indications as to their proximity to obstacles in their environment. In some examples, the environmental data can be used with the actuators 112 to move the second frame 114 relative to the first frame 110 in order to prompt the user to move in a desired direction, such as to move away from boundaries in the user's environment. In some examples, the environmental data can be used to detect or anticipate undesirable environmental conditions. In cases in which an undesirable or uncomfortable environmental condition is detected or anticipated, the actuators 112 can move the second frame 114 away from the first frame 110 to maintain comfortable relative positioning of the user's face and the display 102.

In some examples, the actuators 112 can move the second frame 114 relative to the first frame 110 based on body positions of the user, duration of use of the HMD 100, or the like. For example, the HMD 100 can anticipate that a user desires a more immersive experience with better optical quality when the user is sitting or lying down and decrease the distance between the second frame 114 and the first frame 110 using the actuators 112. The HMD 100 can anticipate that a user desires a less immersive experience and is less concerned with optical quality when the user is standing or moving and increase the distance between the second frame 114 and the first frame 110 using the actuators 112. This can also improve a sense of comfort when the user is moving while wearing the HMD 100 by increasing a distance of the display 102 from the user's face. The HMD 100 can modulate the distance between the second frame 114 and the first frame 110 through the actuators 112 as the HMD 100 is worn for longer periods of time to modulate pressure applied by the HMD 100 to the user's head 101, thereby improving user comfort.

In some examples, the actuators 112 can be used to position the second frame 114 relative to the first frame 110 based on user profiles stored in the HMD 100. The user profiles can be specific to individual users of the HMD 100, and can be selected by the users or automatically selected based on physical features of the user. The user profiles can include user preferences for the relative position of the second frame 114 to the first frame 110. The user profiles can be specific to activity types for activities selected while using the HMD 100. The user profiles can be updated over time, based on user feedback as well as analysis of the users by the HMD 100 while the users use the HMD 100.

The actuators 112 can be positioned at intermediate positions along the straps 116, the band 118 and/or the cover 120. For example, the straps 116 can be coupled to the display 102 and/or the second frame 114 and the actuators 112 can be disposed at intermediate positions along the length of the straps 116. In some examples, the band 118 can be coupled to the display 102 and/or the second frame 114 (e.g., the straps 116 can be omitted and the band 118 can be coupled directly to the display 102 and/or the second frame 114), and the actuators 112 can be disposed at intermediate positions along the length of the straps 116. In some examples, the cover 120 can be coupled to the display 102 and can extend distally, at least partially surrounding the actuators 112, to be coupled to the facial interface 106. As such, adjusting relative positions of the first frame 110 and the second frame 114 can adjust lengths of the straps 116, the band 118 and/or the cover 120. The straps 116, the band 118 and/or the cover 120 can be formed from flexible, elastic materials, can include telescoping elements, can include elements that accordion, or the like.

Although the actuators 112 have been described as being coupled to the first frame 110 and the second frame 114, the relative positions of the display 102 and the user's eyes can be adjusted by actuators disposed at different locations of the HMD 100. In some examples, the first frame 110 can be omitted, and the second frame 114 can be coupled to the facial interface 106 by the actuators 112. In some examples, the first frame 110 can be omitted, the second frame 114 can be coupled to the facial interface 106 through the connectors 108, and the straps 116 can be coupled to the display 102 through the actuators 112. In some examples, the first frame 110 can be omitted, the second frame 114 can be coupled to the facial interface 106 through the connectors 108, and the straps 116 can be coupled to the device seal 122 through the actuators 112.

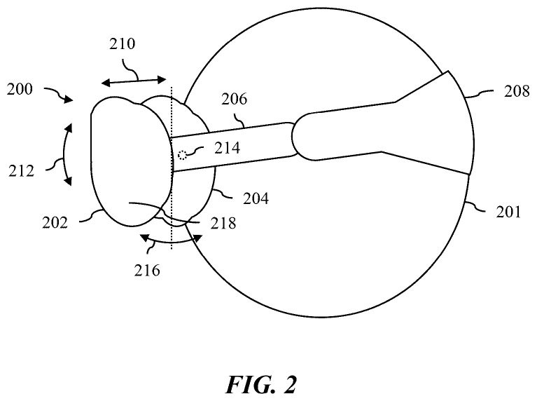

FIG. 2 illustrates a side view of an HMD 200 donned on a user's had 201. The HMD 200 includes a display 202 that is adjustably coupled to a device seal 204. The HMD 200 can be the same as or similar to, including the same or similar components to, the HMD 100, illustrated and discussed with respect to FIGS. 1A and 1B. For example, the HMD 200 includes the display 202 coupled to the device seal 204, straps 206 coupled to the display 202 and/or the device seal 204, and a band 208 coupled to the straps 206. The position of the display 202 relative to the device seal 204 can be adjusted by actuators that can be coupled between the display 202 and the device seal 204, or between the display 202 and the straps 206.

FIG. 2 illustrates movement of the display 202 relative to the device seal 204 that can be provided by the actuators coupled to the display 202 and either of the device seal 204 and/or the straps 206. A distance between the display 202 and the device seal 204 can be adjusted in a direction 210 parallel to longitudinal axes of the straps 206 and perpendicular normal to displays of the display 202. A pitch angle between the display 202 and the device seal 204 can be adjusted in a direction 212 about a pitch axis 214 parallel to a longitudinal axis of the display 202. A yaw angle between the display 202 and the device seal 204 can be adjusted in a direction 216 about a yaw axis 218 perpendicular to the longitudinal axis of the display 202 and the longitudinal axes of the straps 206.

The actuators can be coupled between the display 202 and the device seal 204, or between the display 202 and the straps 206. In examples in which the actuators are coupled between the display 202 and the device seal 204, the device seal 204 can include a first frame, the actuators can be coupled to the first frame, the display 202 can include a second frame, and the actuators can be coupled to the second frame. The actuators can adjust a relative position of the display 202 to the device seal 204 by adjusting relative positions of the second frame and the first frame, as discussed above with respect to FIGS. 1A and 1B. In examples in which the actuators are coupled between the display 202 and the straps 206, the actuators can be coupled to the straps 206 and a frame of the display 202. The actuators can adjust a relative position of the display 202 to the device seal 204 by adjusting relative positions of the frame of the display and the straps 206.

Any number of actuators can be coupled between the display 202 and the device seal 204, or between the display 202 and the straps 206. Providing a greater number of actuators can increase costs of the HMD 200 and can provide control over a greater number of variables in the respective positions of the display 202 and the device seal 204. For example, a single actuator can provide control over the respective positions of the display 202 and the device seal 204 in the direction 210; two actuators can provide control over the respective positions of the display 202 and the device seal 204 in the direction 210 and the direction 212 or the direction 216; and three actuators can provide control over the respective positions of the display 202 and the device seal 204 in the direction 210, the direction 212, and the direction 216. The actuators can be oriented in the direction 210, a direction parallel to the pitch axis 214, a direction parallel to the yaw axis 218, or any other direction. Linkages can be provided between the display 202 and the device seal 204, or between the display 202 and the straps 206 in order to control the relative motion of the display 202 and the device seal 204, regardless of the orientation of the actuators.

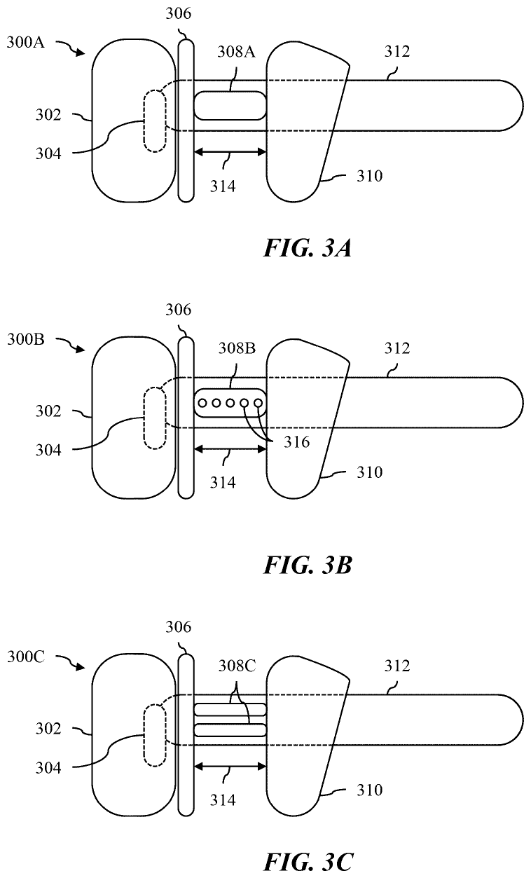

FIGS. 3A through 3C illustrate HMDs 300A-300C including various actuators 308A-308C, respectively. The HMDs 300A-300C can be the same as or similar to, including the same or similar components to, the HMDs 100, 200, illustrated and discussed with respect to FIGS. 1A through 2. For example, the HMDs 300A-300C can include a display 302 including a display 304. The display 302 can be coupled to a display frame 306. Straps 312 can be coupled to the display 302, the display frame 306, and/or a device seal 310. The actuators 308A-308C can be coupled to the display 302 and the device seal 310, to the display 302 and the straps 312, or can be disposed at intermediate positions on the straps 312. The actuators 308A-308C can be used to adjust a position of the display 302 relative to the device seal 310, such as in a distance between the display 302 to the device seal 310 in a direction 314, as well as a relative angle between the display 302 and the device seal 310.

In FIG. 3A, the actuator 308A can include a motor or other linear actuator. The actuator 308A can provide precise, controlled actuation of movement between the display 302 and the device seal 310 in the direction 314. Multiple actuators 308A can be included to provide control over relative positions of the display 302 and the device seal 310 in additional dimensions. The actuator 308A can be an automatic actuator controlled by the HMD 300A in response to content provided by the HMD 300A, feedback provided by sensors of the HMD 300A, user selections provided through the HMD 300A, and the like. The actuator 308A can be a non-backdrivable motor.

In FIG. 3B, the actuator 308B can include a ratchet or detent-based extension. In some examples, the actuator 308B can include a ratchet and a pawl, which can be non-backdrivable in one or two directions. In some examples, the actuator 308B can include a pin and hole arrangement, which can be non-backdrivable in two directions. For example, holes 316 can be provided along a length of a post of the actuator 308B, and a pin can be inserted into a respective hole 316 to maintain a desired position between the display 302 and the device seal 310. The post can be coupled to the display 302 and the pin can be coupled to the device seal 310 or the straps 312, or vice versa. In some examples, the actuator 308B can include a fastener, and can be non-backdrivable in two directions. The actuator 308B can provide discrete amounts of movement in the position of the display 302 relative to the device seal 310 in the direction 314. The actuator 308B can be engaged or disengaged with a dial, a button, or the like. The actuator 308B can be disengaged with a button and engaged by a spring. Multiple actuators 308B can be included to provide control over relative positions of the display 302 and the device seal 310 in additional dimensions. The actuator 308B can be a manual actuator, and the HMD 300B can provide a user with commands or instructions in order to adjust the actuator 308B. The user can actuate the actuator 308B in response to content provided by the HMD 300B, feedback provided by sensors of the HMD 300B, user selections provided through the HMD 300B, and the like.

In FIG. 3C, the actuators 308C can include ejecting extensions. The actuators 308C can be coil-sprung, air-sprung, chemically-sprung or the like. The actuators 308C can be used to quickly move the display 302 away from the device seal 310 in the direction 314, such as in cases of an impending condition or event that would modify the relative positioning of the display 302 relative to the user. Sensors and software of the HMD 300C can detect objects surrounding the HMD 300C, as well as movements of the user of the HMD 300C, and can detect or anticipate falls by the user of the HMD 300C or interaction with objects around the HMD 300C. The HMD 300C can trigger the actuators 308C to move the display 302 away from the device seal 310 and the user's face when an anticipated action or environmental condition warrants. In other words, a controller of the HMD 300C can trigger the actuators 308C to move the display 302 away from the device seal 310 by sending a signal to the actuators 308C, causing the actuators 308C to move the display 302 away from the device seal 310 in response to anticipated action or environmental conditions. In some cases, this triggering can include releasing a pin, ratchet, button, other fastener, or the like that maintains the actuators 308C in an initial position such that the actuators 308C move the display 302 away from the device seal 310. This can ensure a comfortable distance between components of the display and a user's face when wearing the HMD 300C. The actuators 308C can be held in place by a detent (e.g., a pin, ratchet, button, other fastener, or the like), which can be released when the HMD 300C detects an environmental condition that would modify the relative positioning of the display 302 relative to the user, triggering the actuators 308C. The actuators 308C can be non-backdrivable, or can be backdriven by varying amounts of force (e.g., the actuators can include springs with varying stiffness), which can allow for some controlled movement between the display 302 and the device seal 310. The actuators 308C can be automatic actuators, which eject the display 302 away from the device seal 310 in a controlled manner in response to a signal from the HMD 300C.

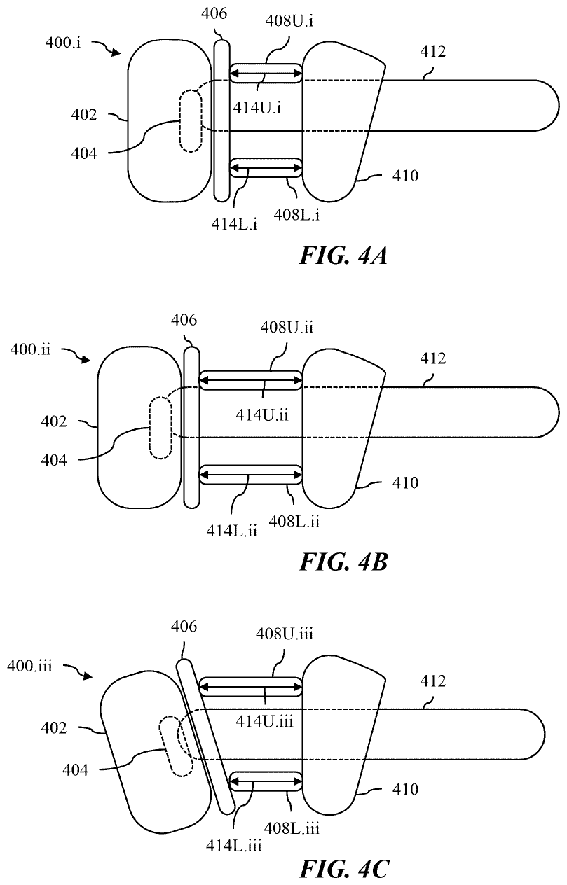

FIGS. 4A through 4C illustrate HMDs 400.i-400.iii (collectively referred to as an HMD 400) with actuators 408 in different positions. The HMDs 400.i-400.iii can be the same as or similar to, including the same or similar components to, the HMDs 100, 200, 300A-300C illustrated and discussed with respect to FIGS. 1A through 3C. For example, the HMDs 400.i-400.iii can include a display 402 including a display 404. The display 402 can be coupled to a display frame 406. Straps 412 can be coupled to the display 402, the display frame 406, and/or a device seal 410. An upper actuator 408U and a lower actuator 408L can be coupled to the display 402 and the device seal 410, to the display 402 and the straps 412, or can be disposed at intermediate positions on the straps 412. The actuators 408 can be used to adjust a position of the display 402 relative to the device seal 410, such as in a distance between the display 402 to the device seal 410, as well as a relative angle between the display 402 and the device seal 410. FIGS. 4A through 4C illustrate the actuators 408 and the HMDs in a first position i, a second position ii, and a third position iii, respectively.

In FIG. 4A, an upper distance 414U.i defined by an upper actuator 408U.i and a lower distance 414L.i defined by a lower actuator 408L.i can be the same, and relatively small. In FIG. 4B, an upper distance 414U.ii defined by an upper actuator 408U.ii and a lower distance 414L.ii defined by a lower actuator 408L.ii can be the same, and relatively large. In FIG. 4C, an upper distance 414U.iii defined by an upper actuator 408U.iii can be larger than a lower distance 414L.iii defined by a lower actuator 408L.iii can be the same. As illustrated in FIG. 4C, this alters a pitch angle of the display 402 relative to the device seal 410. The HMD 400 can also include left and right actuators 408, which can alter a yaw angle of the display 402 relative to the device seal 410. Any number of actuators 408 can be included to alter the relative positions of the display 402 and the device seal 410 in any number of dimensions.

In the example of FIGS. 4A through 4C, the display 402 is coupled to the straps 412. As illustrated in FIGS. 4A through 4C, lengths of the straps 412 can change as the position of the display 402 relative to the device seal 410 is adjusted. This can be accomplished by providing the actuators 408 at intermediate positions along the straps 412, by coupling the actuators 408 between the display 402 and the straps 412, or by including flexible materials, materials that accordion, telescoping features, or the like in the straps 412. In some examples, the straps 412 can be coupled to the device seal 410, in which case the straps 412 can be rigid and do not change as the actuators 408 move. In some examples, the device seal 410 can include a cover that blocks ambient light from penetrating between the display 402 and the user's face. The cover can include flexible materials, materials that accordion, telescoping features, or the like, such that the cover blocks ambient light regardless of the positions of the actuators 408.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A head-mountable electronic device, comprising:
a display unit comprising a display;
a first frame coupled to the display;
a second frame coupled to the first frame by a first actuator; and
a securement strap coupled to the second frame;
wherein:
the first actuator is configured to adjust a distance between the first frame and the second frame; and
the first actuator is non-backdrivable.

2. The head-mountable electronic device of claim 1, wherein the first actuator comprises a motor.

3. The head-mountable electronic device of claim 1, wherein the first actuator comprises a spring.

4. The head-mountable electronic device of claim 3, wherein the spring is configured to increase the distance between the first frame and the second frame in response to a trigger by the head-mountable electronic device.

5. The head-mountable electronic device of claim 1, wherein:
the first actuator comprises a button; and
the distance is configured to be adjusted when the button is actuated.

6. The head-mountable electronic device of claim 1, wherein:
the second frame is further coupled to the first frame by a second actuator; and
the second actuator is configured to adjust an angle of the first frame relative to the second frame.

7. The head-mountable electronic device of claim 1, wherein:
the first actuator comprises a dial; and
the distance is configured to be adjusted when the dial is rotated.

8. A wearable electronic device, comprising:
a display;
a device seal configured to physically interface with a user; and
an actuator coupled to the display and the device seal, the actuator configured to adjust a position of the display unit relative to the device seal in response to a signal from the wearable electronic device.

9. The wearable electronic device of claim 8, wherein:
the actuator comprises a manual actuator; and
the display is configured to display instructions for adjusting the position of the display unit relative to the device seal.

10. The wearable electronic device of claim 8, wherein the actuator is configured to adjust a distance between the display and the device seal.

11. The wearable electronic device of claim 8, wherein the actuator is configured to adjust an angle of the display relative to the device seal.

12. The wearable electronic device of claim 8, wherein:
the actuator is a first actuator;
the first actuator is configured to adjust a distance between the display and the device seal;
the wearable electronic device further comprises a second actuator; and
the second actuator is configured to adjust an angle of the display relative to the device seal.

13. The wearable electronic device of claim 8, wherein the actuator comprises a detent configured to maintain the position of the display relative to the device seal.

14. A head-mountable device (HMD), comprising:
a display;
a facial interface; and
an actuator coupling the display to the facial interface, the actuator comprising a motor configured to adjust a distance between the display and the facial interface.

15. The HMD of claim 14, wherein the actuator is configured to adjust the distance between the display and the facial interface based on an activity setting of the HMD.

16. The HMD of claim 14, wherein the actuator is configured to adjust the distance between the display and the facial interface based on a body position of a user of the HMD.

17. The HMD of claim 14, further comprising a sensor configured to provide feedback related to an environment around the HMD, wherein the actuator is configured to adjust the distance between the display and the facial interface based on the feedback from the sensor.

18. The HMD of claim 14, further comprising a sensor configured to analyze facial features of a user of the HMD, wherein the actuator is configured to adjust the distance between the display and the facial interface based on the facial features of the user.

19. The HMD of claim 14, further comprising:
a sensor configured to detect a gaze of a user of the HMD; and
a second actuator configured to adjust a relative angle between the display and the facial interface based on the gaze of the user detected by the sensor.

20. The HMD of claim 14, wherein the actuator is configured to adjust the distance based on a user profile associated with a respective user of the HMD.
